(19) United States
(12) Patent Application Publication
(10) Pub. No.: US 2019/0112814 A1
(43) Pub. Date: Apr. 18, 2019

(54) PREFABRICATED ASPHALT-BASED WATERPROOF ROOFING MEMBRANE

(71) Applicant: Curacreto, SA de CV, Mexico City (MX)

(72) Inventors: Jorge Augusto Robles-Ramos, Mexico City (MX); Jorge Robles-Glenn, Mexico City (MX)

(21) Appl. No.: 15/783,462

(22) Filed: Oct. 13, 2017

(51) Int. Cl. E04D 5/10; E04D 11/02; B32B 11/10; B32B 27/30; B32B 5/02

(52) U.S. Cl. CPC E04D 5/10; E04D 11/02; E04D 5/12; B32B 27/308; B32B 5/022; B32B 11/10

(57) ABSTRACT

A prefabricated modified bitumen waterproofing membrane includes a middle layer formed of a non-woven polyester and/or fiberglass reinforcement fabric, an upper layer and a bottom layer of modified bitumen asphalt, aluminum flakes on a top surface of the upper layer, and polyolefin film covering the bottom layer. A process for manufacturing the prefabricated modified bitumen waterproofing membrane includes modifying the asphalt with SBS (Styrene-Butadiene-Styrene), APP (Attic Polypropylene) or TPO (Thermoplastic Polyolefin) polymers, saturating the top and bottom sides of the middle layer of reinforcement fabric with the modified asphalt, applying the aluminum flakes to the top surface, and applying a polyethylene film to the bottom surface.

### FIELD OF THE INVENTION

The present invention relates to waterproofing membranes for waterproofing different types of surfaces in residential, industrial or commercial buildings and, more particularly, to a waterproofing membrane and manufacturing process therefor wherein a central reinforcement of non-woven fabric of polyester fiber and/or fiberglass is saturated on both sides with asphalt that has been modified to give it plasticity with SBS (Styrene-Butadiene-Styrene) polymers or APP (Attic Polypropylene) or TPO (Thermoplastic Polyolefin); and subsequently aluminum flake is added to the top side of the saturated reinforcing substrate as a finish coating to impart the property of high reflectance to the sun rays, as well as the ultraviolet and infrared rays.

### BACKGROUND OF THE INVENTION

Today, many actions are taken to reduce the problem of earth warming due the emanation of greenhouse gases such as carbon dioxide (CO2).

One significant problem caused by greenhouse gases is the overheating of cities (Urban Heat Island Effect). Urban areas cover only 2.8% of the total surface of our planet, however, they are responsible for 75% of the global consumption of resources (Key World Energy Statistic 2013) as a result of the absorption and the Irradiation of the solar rays reflected from buildings and street surfaces.

Roofs of houses and buildings, as well as streets with horizontal surfaces, account for a large percentage of the total surface area of a city that is exposed to direct sunlight. These surface areas receive solar rays throughout most of the day and can be equipped to deliver high solar reflectance (i.e., the ability to reflect the visible, infrared and ultraviolet wavelengths of the sun, and thereby reducing heat transfer to the surface) and high thermal emittance (i.e., the ability to radiate absorbed or non-reflected solar energy).

Use of reflective surfaces in residential, industrial and commercial buildings and structures is a form of geoengineering. The most well-known type of reflective roof surface is the Cool Roof. While Cool Roofs are mostly associated with white roofs, they come in a variety of colors and materials and are available for both commercial and residential buildings.

In hotter climates, Cool Roofs can offer both immediate and long-term benefits including:
Savings of up to 15% the annual air-conditioning energy use of a single-story building.
Help in mitigating the Urban Heat Island Effect.
Reduced air pollution and greenhouse gas emissions, as well as a significant offsetting of the warming impact of greenhouse gas emissions.

Cool Roofs achieve cooling energy savings in hot summers, but can increase heating energy load during cold winters. Therefore, the net energy saving of Cool Roofs varies depending on climate. However, a 2010 energy efficiency study looking at this issue for air-conditioned commercial buildings across the United States found that the summer cooling savings typically outweigh the winter heating penalty, even in cold climates near the Canada-US border. The result is savings in both electricity and emissions. However, without a proper maintenance program to keep the material clean, the energy savings of Cool Roofs can diminish over time due to albedo degradation and soiling.

Research and practical experience with the degradation of roofing membranes over a number of years have shown that heat from the sun is one of the most potent factors that affect durability. High temperatures and large temperature variations, seasonally or daily, at the roofing level are detrimental to the longevity of roof membranes. Reducing the extremes of temperature change will reduce the incidence of damage to membrane systems. Covering membranes with materials that reflect ultraviolet and infrared radiation will reduce damage caused by UV and heat degradation. Accordingly, white surfaces reflect more than half of the radiation that reaches them, while black surfaces absorb almost all. White or white coated roofing membranes or white gravel cover can be an effective approach to control these problems where membranes must be left exposed to solar radiation.

It has been discovered that coatings containing aluminum flakes can have between 40 to 50% higher SRI Solar Reflectance Index compared to white coatings. In fact, if all flat roofs in warm climate urban areas were aluminized, the result would be a 10% increase in global reflectivity. This would offset the warming effect of 24 gigatonnes of greenhouse gas emissions, or the equivalent to taking 300 million cars off the road for 20 years. This is because a 93-square-metre (1,000 sq. ft.) aluminum roof will offset 10 tons of carbon dioxide over its 20-year lifetime. In a real-world 2008 case study of large-scale cooling from increased reflectivity, it was found that the Province of Almeria, Southern Spain, has cooled 1.6° C. over a period of 20 years compared to surrounding regions, as a result of polythene-covered greenhouses being installed over a vast area that was previously open desert. In the summer the farmers whitewash these roofs to cool their plants down. The whitewashed roofs reflect a considerable amount of the sun's rays, resulting in cooling of this region.

When sunlight falls on an aluminum roof, much of it is reflected and passes back through the atmosphere into space. But when sunlight falls on a dark roof, most of the light is absorbed and is re-radiated as much longer wavelengths, which are absorbed by the atmosphere. The gases in the atmosphere that most strongly absorb these long wavelengths have been termed “greenhouse gases”.

A 2012 study by researchers at Concordia University included variables similar to those used in the Stanford study (e.g., cloud responses) and estimated that worldwide deployment of Cool Roofs and pavements in cities would generate a global cooling effect that reduces up to 150 gigatonnes of carbon dioxide emissions—the equivalent of taking every car in the world off the road for 50 years.

Albedo is a measure for reflectance or optical brightness of a surface. It is dimensionless and measured on a scale from zero (corresponding to a black body that absorbs all incident radiation) to one (corresponding to a white body that reflects all incident radiation). The albedo measurement for various types of surface coatings and materials is shown below:

| FINISH | EFFECT ALBEDO |
|---|---|
| Aluminum flake | 1.0 |
| Aluminum paint | 0.9 |
| White paint | 0.85 |
| Tan paint | 0.35 |
| Tan clay tile | 0.25 |
| Red granules | 0.18 |
| Tan corrugated roof | 0.15 |

As shown in Table 1 and Table 2 (below), the use of an aluminum flake top coating reduces the heat absorption of the surfaces on which it is applied on the buildings roofs. This generates a reduction in the warming of the inside temperature of the building structure, thus reducing the electricity needed to operate the air conditioning equipment that regulates the building interior temperatures. The reduction of consumption of electric energy helps to reduce the emission of greenhouse gases, such as carbon dioxide, into the atmosphere.

TABLE 1
Measurements made on Jul. 15, 2017 on a Mexico City Roof.

| | | | | | | | | | | Gradient | |
|---|---|---|---|---|---|---|---|---|---|---|---|
| | Initial | | | | | | | (Final | | Difference | |
| | temperature | | | | | | | temperature | | with | |
| | (IT) of the | | | | | | | (FT) of the | | Aluminum | |
| Products-Measuring | surface 9:00 | | | | | | | surface) | Gradient | Flakes Top | |
| Hours in Celsius Degrees | hours | 9:15 | 10:00 | 11:00 | 12:00 | 13:00 | 14:00 | 15:00 hours | (FT − IT) | Surface | |
| 1.- Prefabricated | 17.9 | 18.1 | 19.2 | 21.3 | 25.4 | 28.3 | 30.5 | 34.6 | 16.7 | 0° | C. |
| waterproofing membrane | | | | | | | | | | | |
| with an Aluminum Flake | | | | | | | | | | | |
| finish | | | | | | | | | | | |
| 2.- Prefabricated | 17.9 | 17.9 | 21.1 | 26.0 | 25.5 | 31.3 | 34.8 | 40.3 | 22.4 | +5.7° | C. |
| waterproofing membrane | | | | | | | | | | | |
| with white granules | | | | | | | | | | | |
| coated with a high | | | | | | | | | | | |
| reflective acrylic | | | | | | | | | | | |
| elastomeric top coat finish | | | | | | | | | | | |
| 3.- Prefabricated | 17.9 | 22.8 | 18.7 | 29.4 | 26.7 | 35.5 | 38.4 | 43.0 | 25.1 | +8.4° | C. |
| waterproofing membrane | | | | | | | | | | | |
| with an Aluminized | | | | | | | | | | | |
| granule finish | | | | | | | | | | | |
| 4.- Prefabricated | 17.9 | 22.7 | 31.1 | 36.9 | 36.5 | 46.8 | 50.3 | 53.8 | 35.9 | +19.2° | C. |
| waterproofing membrane | | | | | | | | | | | |
| with a white granule finish | | | | | | | | | | | |
| 5.- Prefabricated | 17.9 | 24.8 | 33.6 | 45.3 | 44.2 | 54.5 | 60.4 | 61.9 | 44.0 | +27.3° | C. |
| waterproofing membrane | | | | | | | | | | | |
| with a tan granule finish | | | | | | | | | | | |
| 6.- Prefabricated | 17.9 | 22.8 | 32.6 | 40.3 | 41.3 | 52.3 | 55 | 61.1 | 43.2 | +26.5° | C. |
| waterproofing membrane | | | | | | | | | | | |
| with a green granule finish | | | | | | | | | | | |

TABLE 2
Measurements made on Jul. 23, 2017 on a Cancun, Mexico

| | | | | | | | | | | Gradient |
|---|---|---|---|---|---|---|---|---|---|---|
| | Initial | | | | | | | Final | | difference |
| | Temperature | | | | | | | Temperature | | with |
| | (IT) of the | | | | | | | (FT) of the | | Aluminum |
| Products-Measuring Hours | surface 9.00 | | | | | | | surface 15:00 | Gradient | Flakes Top |
| in Celsius Degrees | hours | 09:15 | 10:00 | 11:00 | 12:00 | 13:00 | 14:00 | hours | (FT − IT) | Surface |
| 1.- Prefabricated | 23 | 25.7 | 26.8 | 28.5 | 31.2 | 32.9 | 36.4 | 39 | 16 | 0 |
| waterproofing membrane | | | | | | | | | | |
| with an Aluminum Flake | | | | | | | | | | |
| 2.- Prefabricated | 23 | 24.2 | 32.1 | 36.4 | 38.2 | 41.3 | 43.8 | 45.1 | 22.1 | 6.1 |
| waterproofing membrane | | | | | | | | | | |
| with white granules coated | | | | | | | | | | |
| with a high reflective | | | | | | | | | | |
| acrylic elastomeric top | | | | | | | | | | |
| coat finish | | | | | | | | | | |
| 3.- Prefabricated | 23 | 25.4 | 32.4 | 38.5 | 41.6 | 44.5 | 44.9 | 47.1 | 24.1 | 8.1 |
| waterproofing membrane | | | | | | | | | | |
| with an Aluminized | | | | | | | | | | |
| granule finish | | | | | | | | | | |
| 4.- Prefabricated | 23 | 25.7 | 33.5 | 45.3 | 53.8 | 58.4 | 59.7 | 61.3 | 38.3 | 22.3 |
| waterproofing membrane | | | | | | | | | | |
| with a white granule finish | | | | | | | | | | |
| 5.- Prefabricated | 23 | 26.8 | 35.3 | 47.9 | 52.6 | 61.5 | 65.2 | 69.1 | 46.1 | 30.1 |
| waterproofing membrane | | | | | | | | | | |
| with a tan granule finish | | | | | | | | | | |
| 6.- Prefabricated | 23 | 29.5 | 39.7 | 49.2 | 56.4 | 64.3 | 66.8 | 72.4 | 49.4 | 33.4 |
| waterproofing membrane | | | | | | | | | | |
| with a green granule finish | | | | | | | | | | |

Today, reducing the global warming problem of emanating greenhouse gases into the atmosphere caused by solar rays on roofs which increase temperatures in urban areas is a world-wide task. The increasing consumption of energy used to lower the interior temperature in buildings has added to the global and regional problem of warming of the environment. This has caused a transformation in contemporary technologies for the development of Cool Roof products. There are several private institutions in the United States, USGBC “US Green Building Council”, “Leadership in Energy and Environmental Design” LEED, EPA “Environmental Protection Agency”, Energy Star and “Cool Roof Rating Council” CRRC, that encourage among other issues the reduction of global warming, through guidelines that the Government Of the United States rewards with reduction in property taxes for constructions with low environmental impact.

To reduce this global warming problem, a prefabricated modified bitumen waterproofing membrane of the present invention has been developed, with aluminum flake as a finished surface coating. The aluminum flake surface coating reflects more than 85% of the solar rays which fall on roofs, increasing the solar ray reflectance capacity of roofs, and reducing the surface temperature of the prefabricated modified bitumen waterproofing membrane by between 19.2 and 27.3° C.

To reduce the production of greenhouse gases and global warming, particularly in urban areas where a high percentage of the area of a city is the roofs of different types of buildings, a prefabricated modified bitumen waterproofing membrane of the present invention has been developed, with aluminum flake finish coating, which has a Solar Reflectance Index (SRI) of 87 (Report 160921CU dated Sep. 29, 2016, issued by Comprehensive Sustainable Designs 3e, S.C.) measurements made with emisometer equipment that detects radiant energy and solar reflectometer, using ASTM test methods. See Table 3. This modified bitumen waterproofing roofing membrane reflects the greatest amount possible of solar rays, resulting in a reduction of the amount of electrical energy used in air condition equipment in buildings, homes, shopping centers and industries.

TABLE 3
Prefabricated waterproofing membrane with aluminum flake finish

| TEST | INITIAL | 3-year aged* |
|---|---|---|
| Reflectance (ASTM Cl549) | 0.772 | 0.720 |
| Emittance (ASTM Cl371) | 0.19 | 0.19 |
| Solar Reflectance Index (SRI) | 87 | 80 |
| (ASTM E 1980) | | |

*Tested in accordance with ASTM D 7897

Today prefabricated modified bitumen waterproofing membranes are manufactured with top coatings of different colored mineral granules, these have a Solar Reflectance Index (SRI) of less than 40, allowing roofs to increase their surface temperature during the day when the sun's rays heat the roofs, see Table 4.

TABLE 4
Solar Reflectance Index (SRI) Comparison

| | | | | Observa- |
|---|---|---|---|---|
| Product | SRI | Reflectance | Emittance | tions |
| 1.- Prefabricated water- | 87/80* | 0.77/0.72* | 0.69/0.69* | *3-year |
| proofing membrane with | | | | aged |
| an aluminum flake top | | | | |
| coat | | | | |
| 2.- Prefabricated water- | 78 | 0.95 | 0.75 | |
| proofing membrane with | | | | |
| an aluminized granule | | | | |
| top coat | | | | |
| 3.- Prefabricated water- | 25/25* | 0.26/0.27* | 0.87/0.84* | *3-year |
| proofing membrane with | | | | aged |
| a white granule top | | | | |
| coat | | | | |

### Objects and Advantages of the Invention

One of the objectives of the present invention is to provide a prefabricated modified bitumen waterproofing membrane which reduces the thermal emission (Urban Heat Island Effect) caused by the absorption of solar rays in the roofs of cities, to thereby reduce greenhouse gases, taking into account that almost 30% of the surface in urban areas are roofs.

It is also an object of the present invention to manufacture a prefabricated modified bitumen waterproofing membrane which has a Solar Reflectance Index (SRI) of at least 85.

It is a further object of the present invention to provide a prefabricated modified bitumen waterproofing membrane that is installed over a waterproofing area and which reflects more than 85% of solar rays and diminishes the Urban Heat Island Effect.

These and other objects and advantages of the present invention are more readily apparent with reference to the following detailed description taken in conjunction with the accompanying drawings.

### SUMMARY OF THE INVENTION

The present invention falls within the field of the construction industry and relates to a prefabricated waterproofing membrane, and a manufacturing process therefor, used to waterproof different types of surfaces in residential, industrial or commercial buildings. The prefabricated waterproofing membrane is manufactured continuously and the process includes: as a first step, a central reinforcement of non-woven fabric of polyester fiber and/or fiberglass, which is saturated on both sides with asphalt. Before entering in the process, the asphalt is modified with SBS (Styrene-Butadiene-Styrene) polymers, APP (Attic Polypropylene) or TPO (Thermoplastic Polyolefin) to provide plasticity and properties of elongation and tension. Thereafter, the aluminum flake is added at the upper layer as a finish coating. This imparts the property of high reflectance to the sun rays, as well as the ultraviolet and infrared rays.

### BRIEF DESCRIPTION OF THE DRAWINGS

FIG. 1 shows a schematic diagram of the manufacturing process of the prefabricated modified bitumen waterproofing membrane of the invention. Initially in the process, a central reinforcement, which may be fiberglass, polyester fiber or a mixture of both, is placed on a support base that allows the roll to rotate and the reinforcement begins to integrate to the next steps of the process. The reinforcement is driven by a roller system which is directed at a controlled speed to a tank containing the modified asphalt mixture where it is immersed in this mixture and the reinforcement is saturated entirely and to the corresponding thickness desired, the now called roofing membrane passes through a several rollers that are calibrated to remove the excess asphalt mixture and fix the desired thickness. The continuous production line reaches the stage where, through a hopper, the aluminum flake finish is spread on top of the modified bitumen asphalt and a polyethylene film is placed on the bottom. The prefabricated modified bitumen waterproofing membrane is then passed by several cooling rollers, whose function is to ensure the adhesion of the aluminum flake on the asphalt and to adhere to the bottom film of polyethylene. Finally, the prefabricated modified bitumen waterproofing membrane reaches the final stage of the process where it is cut at the desired length and rolled, placing 3 fastening tapes and is placed on pallets for handling and storage as a finished product.

FIG. 2 is a perspective view of the waterproofing membrane of the present invention shown pulled from a roll and further illustrating the different layers of the waterproofing membrane of the invention including: layer (b) asphalt modified with SBS, APP or TPO; layer (c) non-woven reinforcing polyester and/or fiberglass; layer (d) polyethylene film; and layer (a) aluminum flake.

### DESCRIPTION OF THE PREFERRED EMBODIMENTS

Definitions:

In order to facilitate the understanding of the invention, certain terms are defined below.

The term “aluminum flake” defines very fine, narrow and very thin powder and/or flake of high purity aluminum, which, through a grinding and separation process, obtains its distribution characteristics through a Gilson SS-15 sieve.

The term “prefabricated modified bitumen waterproofing membrane”, is defined as a prefabricated asphalt-based waterproof roofing membrane made with modified asphalt with SBS (Styrene-Butadiene-Styrene), APP (Attic Polypropylene) or TPO (Polyolefin Thermoplastic), and finished in its top layer of aluminum flake that provides it the property of high reflectance to the solar rays.

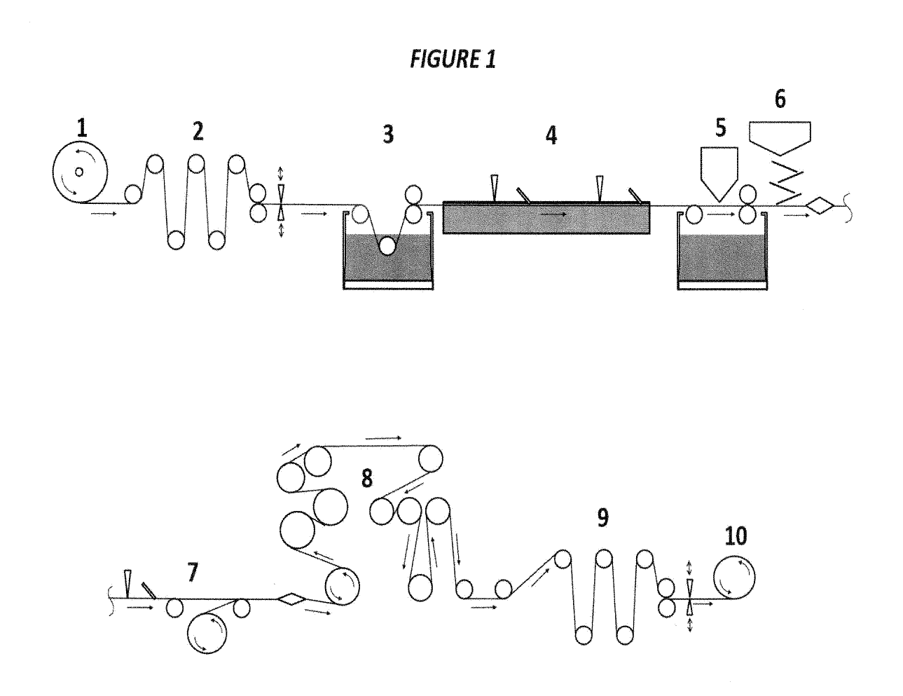

FIG. 1 shows the process of manufacture of the Prefabricated Waterproofing Membrane of the invention.

The process starts at the point (1) in FIG. 1, in which the roll of the central reinforcement fabric of the waterproofing membrane, which could be fiberglass from 90 to 120 gr/m² or polyester fiber from 170 to 250 gr/m², is settled over a support base equipment with a rotating cylindrical shaft, which allows the central fabric of the Prefabricated modified bitumen Waterproofing Membrane to start the manufacturing process unwinding continuously. At point (2) the central reinforcing fabric enters the accumulator which is a set of rollers, that move up and down, so that the reinforcement fabric is always available to allow time to add a new roll of fabric and maintaining a continuous process.

After passing the accumulator, the central reinforcement fabric, reaches point (3) where it enters a tank containing the bitumen asphalt modified with polymers which has been previously prepared in a reactor where the asphalt, polymers, special fillers and additives are blended to produce the modified bitumen asphalt. Other types of products, such as fungicides to avoid the growth of vegetation, fire retardants or other chemical products, can be added to improve physical-chemical, mechanical or chemical properties of the mixture. The temperature of the modified bitumen asphalt in the tank is between 150° C. to 185° C. in which the reinforcement fabric is saturated, and passes through the thickness rollers.

At the point (4) the roofing membrane enters a cooling system where the temperature of the modified bitumen asphalt is lowered to between 80 to 90° C. at the end of the cooling system.

The process continues to point (5) where the roofing roll has an average temperature of between 65-70° C. and passes where the final thickness is set between 1.4 to 5.0 mm

At point (6), the aluminum flakes are loaded to a hopper, and through a series of metal trays, the aluminum flakes are spread covering completely the top surface of the Prefabricated Modified Bitumen Waterproofing Membrane at an average of 6 million aluminum flakes per every square meter of product area, to produce the final product. This process is completely different compared to other types of modified waterproofing rolls, where mineral granules or silica sand are applied to the top layer.

At point (7) of FIG. 1, a polyethylene film is placed in the bottom of the roofing roll. At point (8), the Prefabricated Modified Bitumen Waterproofing Membrane is completely finished and goes through a series of cooling rolls that lower the temperature to between 35-40° C.

At point (9), the waterproofing membrane is passed to an accumulator that controls the feeding of the membrane to the winder. At point (10), the waterproofing membrane is cut and taped at the desired length, and the finished roofing rolls are placed on the pallet for handling and storage.

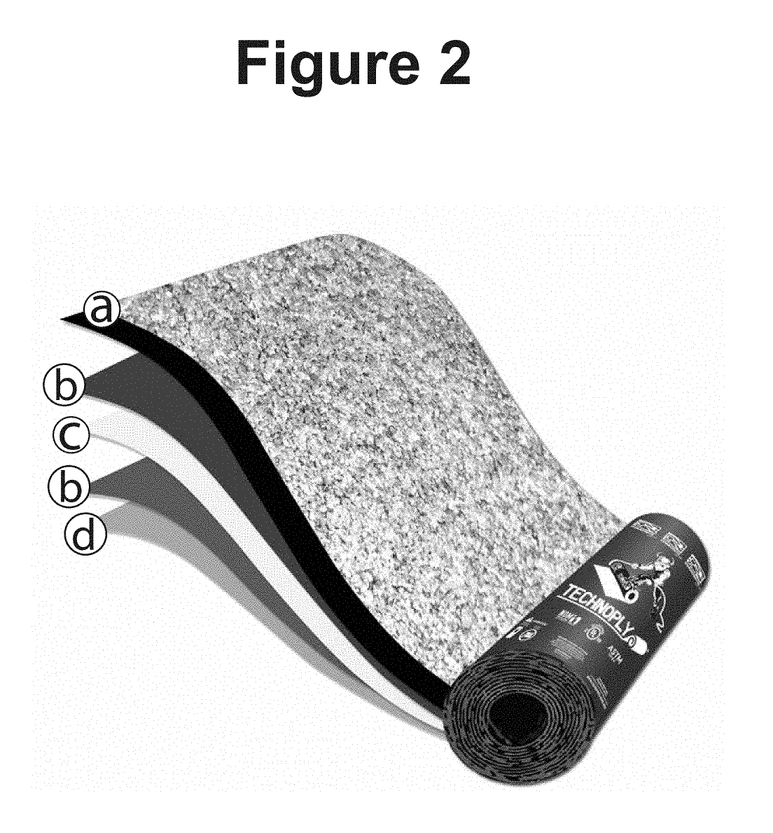

The component layers of the prefabricated modified bitumen waterproofing membrane of the present invention are illustrated in FIG. 2. Specifically, the prefabricated modified bitumen waterproofing membrane is shown pulled from a roll and the component layers being separated for illustration purposes include a top layer comprising aluminum flakes, modified bitumen asphalt with SBS, APP or TPO, as an upper layer on top of a reinforcing fabric formed of a non-woven polyester and/or fiberglass reinforcement fabric that provides the middle layer of the prefabricated modified bitumen waterproofing membrane, a bottom layer of modified bitumen asphalt with SBS, APP or TPO and polyolefin film covering the bottom layer. The amount of the composition for each component is shown in Table 5 below.

TABLE 5
Composition per m²

| Component | Range |
|---|---|
| Modified asphalt (kg.) | 3-5 |
| Reinforcement fabric (m²) | 1.0 |
| Aluminum flakes (kg.) | 1.0-1.4 |
| Polyethylene film (m²) | 1.0 |

While the present invention has been shown in accordance with a preferred and practical embodiment, it is recognized that departures from the instant disclosure are fully contemplated within the spirit and scope of the present invention which is not to be limited except as defined in the following claims.

What is claimed is:

1. A high solar reflectance prefabricated modified bitumen waterproofing membrane comprising:
a middle layer comprising a non-woven polyester and/or fiberglass reinforcement fabric;
an upper layer on the reinforcement fabric comprising modified bitumen asphalt with SBS (Styrene-Butadiene-Styrene), APP (Attic Polypropylene) or TPO (Thermoplastic Polyolefin) polymers;
aluminum flakes on the top surface of the upper layer;
a bottom layer on the reinforcement fabric comprising modified bitumen asphalt with SBS (Styrene-Butadiene-Styrene), APP (Attic Polypropylene) or TPO (Thermoplastic Polyolefin) polymers; and
polyolefin film covering the bottom layer.

2. A manufacturing process for the production of the prefabricated modified bitumen waterproofing membrane of claim 1, the process comprising the steps of:
providing a modified asphalt that includes SBS (Styrene-Butadiene-Styrene), APP (Attic Polypropylene) or TPO (Thermoplastic Polyolefin) polymers;
pumping the modified asphalt into one or more fabric saturation tanks;
maintaining the modified asphalt at a temperature of between 150 degrees C. and 220 degrees C.;
providing a roll of central reinforcement fabric;
placing the roll of central reinforcement fabric on a support base which allows the roll to rotate while the central reinforcement fabric advances through the steps of the manufacturing process in a continuous production line;
driving rotation of the roll of central reinforcement fabric by a guide roller system;
rotating the roll of central reinforcement fabric at a controlled rate and directing the central reinforcement fabric pulled from the roll towards the one or more fabric saturation tanks containing the modified asphalt;
passing the central reinforcement fabric through the one or more fabric saturation tanks;
submerging the central reinforcement fabric in the modified asphalt in the one or more fabric saturation tanks so that the central reinforcement fabric is saturated with the modified asphalt;
directing the saturated central reinforcement fabric out from the one or more fabric saturation tanks and through thickness control cylinders to yield a modified bitumen waterproofing membrane having a thickness ranging between 1.4 mm and 5.0 mm;
allowing the thickness of the modified bitumen waterproofing membrane to set;
spreading aluminum flakes on an upper surface of the modified bitumen waterproofing membrane;
applying a polyethylene film to a bottom surface of the modified bitumen waterproofing membrane;
passing the modified bitumen waterproofing membrane through presses to ensure adhesion of the aluminum flakes and the polyethylene film to the modified asphalt of the modified bitumen waterproofing membrane;
cutting the modified bitumen waterproofing membrane to a desired length; and
winding the cut length of modified bitumen waterproofing membrane into a roll and taping the roll to prevent unwinding.

3. The manufacturing process of claim 2 further comprising the step of applying the aluminum flake as an upper finish coating of the modified bitumen waterproofing membrane to provide high solar reflectance having a solar reflectance index (SRI) equal or greater than 85.

4. The manufacturing process of claim 2 wherein the modified asphalt further includes one or more additives to improve performance of the manufactured modified bitumen waterproofing membrane.

5. The manufacturing process of claim 4 wherein the one or more additives includes fungus and vegetation growth chemical inhibitors.

6. The manufacturing process of claim 4 wherein the one or more additives includes a water repellant.

7. The manufacturing process of claim 4 wherein the one or more additives includes fire retardant chemicals.

8. The manufacturing process of claim 2 wherein the central reinforcement fabric includes fiberglass.

9. The manufacturing process of claim 2 wherein the central reinforcement fabric includes a polyester fiber.

10. The manufacturing process of claim 2 wherein the central reinforcement fabric includes a blend of fiberglass and polyester fiber.
